(19) United States
(12) Patent Application Publication
(10) Pub. No.: US 2006/0129712 A1
(43) Pub. Date: Jun. 15, 2006

(54) Buffer chip for a multi-rank dual inline memory module (DIMM)

(76) Inventor: Siva Raghuram, Germering (DE)

Correspondence Address: JENKINS, WILSON & TAYLOR, P. A., 3100 TOWER BLVD, SUITE 1200, DURHAM, NC, 27707, US

(21) Appl. No.: 11/010,247

(22) Filed: Dec. 10, 2004

(51) Int. Cl. G06F 5/00

(52) U.S. Cl. 710/52

(57) ABSTRACT

The invention refers to a buffer chip for driving external input signals applied to a multi-rank dual inline memory module (DIMM) to a predetermined number (N) of memory chips mounted on a printed circuit board of said dual inline memory module, wherein the buffer chip comprises stacked register dies each having several signal drivers, wherein at least two signal drivers are connected in parallel to drive an external input signal to said memory chips.

### BACKGROUND OF THE INVENTION

1. Field of the Invention

The invention relates in general to a buffer chip for a multi-rank dual inline memory module (MR-DIMM) and in particular to a command and address bus buffer chip for a registered Multi-Rank Dual Inline Memory Module (DIMM).

2. Description of the Prior Art

Memory modules are provided for increasing the memory capacity of a computer system. Originally single inline memory modules (SIMM) were used in personal computers to increase the memory size. A single inline memory module comprises DRAM chips on its printed circuit board (PCB) only on one side. The contacts for connecting the printed circuit board of the single inline memory module (SIMM) are redundant on both sides of the module. A first variant of SIMMs has thirty pins and provides 8 bits of data (9 bits in parity versions). A second variant of SIMMs which are called PS/2 comprise 72 pins and provide 32 bits of data (36 bits in parity versions).

Due to the different data bus width of the memory module in some processors, sometimes several SIMM modules are installed in pairs to fill a memory bank. For instance, in 80386 or 80486 systems having a data bus width of 32 bits either four 30 pins SIMMs or one 72 pin SIMM are required for one memory bank. For pentium systems having a data bus width of 64 bits two 72 pin SIMMs are required. To install a single inline memory module (SIMM) the module is placed in a socket. The RAM technologies used by single inline memory modules include EDO and FPM.

Dual Inline Memory Modules (DIMM) began to replace single inline memory modules (SIMM) as the predominant type of memory modules when Intels pentium processors became wide spread on the market.

While single inline memory modules (SIMMS) have memory units or DRAM chips mounted only on one side of their printed circuit boards (PCB) a dual inline memory modules (DIMMS) comprise memory units mounted on both sides of the printed circuit boards of the modules.

There are different types of Dual Inline Memory Modules (DIMM). An unbuffered Dual Inline Memory-Module does not contain buffers or registers located on the module. These unbuffered Dual Inline Memory Modules are typically used in desktop PC systems and workstations. The number of pins are typically 168 in single data rate (SDR) memory modules, 184 pins in double data rate modules and in DDR-2 modules. DDR-2-DRAMs are a natural extension of the existing DDR-DRAMs. DDR-2 has been introduced at an operation frequency of 200 MHz and is going to be extended to 266 MHz (DDR-2 533), 333 MHz (DDR-2 667) for the main memory and even 400 MHz (DDR-2 800) for special applications. DDR-SDRAM (synchronous DRAMs) increase speed by reading data on both the rising edge and the falling edge of a clock pulse, essentially doubling the data bandwidth without increasing the clock frequency of a clock signal.

A further type of Dual Inline Memory Module (DIMM) is a registered Dual Inline Memory Module. A registered Dual Inline Memory Module comprises several additional circuits on the module in particular a redriver buffer component like a register to redrive command address signals. Further a phase locked loop (PLL) is provided for timing alignments to redrive clock signals. Registered Dual Inline Memory Modules are typically used in highend servers and highend workstations.

ECC-Dual Inline Memory Modules comprise error correction bits or ECC bits. This type of Dual Inline Memory Module has a total of 64 data bits plus 8 ECC bits and is used mostly for server computers. Registered Dual Inline Memory Modules either with ECC or without ECC are used for SDR, DDR and DDR-2.

A further type of Dual Inline Memory Modules are so called small outline DIMM (SO-DIMM). They are an enhanced version of standard Dual Inline Memory Modules and are used in laptops and in some special servers.

A Dual Inline Memory Module comprises a predetermined number N of memory chips (DRAMs) on its printed circuit board. The data width of each memory chip is typically 4 bits, 8 bits or 16 bits. Nowadays personal computer mostly uses a unbuffered Dual Inline Memory Module if a DIMM is selected as the main memory. However, for a computer system with higher main memory volume requirements, in particular a server, registered Dual Inline Memory Modules are the popular choice.

Since memory requirements in a computer system are increasing day by day i.e. both in terms of memory size and memory speed it is desired to place a maximum number of memory chips (DRAMs) on each memory module (DIMM).

FIG. 1 shows a Dual Inline Memory Module according to the state of the art. The Dual Inline Memory Module comprises N DRAM chips mounted on the upper side of the printed circuit board (PCB). The registered Dual Inline Memory Module as shown in FIG. 1 comprises a command and address buffer which buffers command and address signals applied to the Dual Inline Memory Module by a main motherboard and which outputs these signals via a command and address bus (CA) to the DRAM chips mounted on the printed circuit board. A chip selection signal S is also buffered by the command and address buffer and is provided for selecting the desired DRAM chip mounted on the DIMM circuit board. All DRAM chips are clocked by a clock signal CLK which is buffered by a clock signal buffer which is also mounted on the Dual Inline Memory Module (DIMM). Each DRAM chip is connected to the motherboard by a separate databus (DQ) having q data lines. The data bus of each DRAM chip comprises typically 4 to 16 bits.

FIG. 2 shows a cross section of the Dual Inline Memory Module (DIMM) as shown in FIG. 1 along the line A-A′. To increase the memory capacity the DIMM has DRAM chips mounted on both sides of the printed circuit board (PCB). There is a DRAM chip on the top side of the DIMM module and a DRAM chip on the bottom side of the DIMM module. Accordingly the DRAM Dual Inline Memory Module as shown in FIG. 2 comprises two memory ranks or memory levels, i.e. memory rank 0 and memory rank 1.

To increase the memory capacity of a Dual Inline Memory Module (DIMM) further stacked DRAM chips have been developed.

FIG. 3 shows a stacked DRAM chip having an upper memory die and a lower memory die thus providing two memory ranks within one stacked DRAM chip. The two memory dies are packaged within one chip on a substrate. The stacked DRAM chip is connected to the printed circuit board via pads such as solder balls. Dual Inline Memory Modules which have stacked DRAM chips as shown in FIG. 3 on both sides of the printed circuit board have four memory ranks, i.e. two memory ranks on the top side and two memory ranks on the bottom side.

In current computer Dual Inline Memory Modules having two memory ranks are allowed. When increasing the number of memory ranks within the memory systems to four memory ranks or even eight memory ranks the load on the DQ bus and the CA bus as shown in FIG. 1 is increased. For the CA bus the increase of load is not dramatically since the command and address bus (CA) is running at half speed in comparison to the data bus and the command and address buffer redrives the address and command signals applied by the processor on the motherboard to the Dual Inline Memory Module. The increase of memory ranks on the Dual Inline Memory Module however causes an increase of the load of the DQ-data bus which is driven by the controller on the motherboard. The data rate on the DQ-busses is very high in particular when running at DDR-2 data rate. Consequently an increase of the load connected to each DQ data bus deteriorates rates the data signals further so that data errors can not be excluded. Accordingly there is a limitation of the number M of memory ranks within a DRAM chip connected to the DQ-bus of said chip. By limiting the number of memory ranks allowed within a DRAM chip the memory capacity of a Dual Inline Memory is also limited.

To increase the number of DRAM chips on the printed circuit board of the dual inline memory module (DIMM) the DRAM chips are most dual inline memory modules mounted in two rows. FIG. 4 shows a dual inline memory module according to the state of the art having two rows of DRAM memory chips on one side of the printed circuit board. In a typical embodiment low to five DRAM memory chips are provided within each row. Since the same number of the DRAM chips are mounted on the backside of the printed circuit board the total number of DRAM memory chips of a state of the art dual memory module as shown in FIG. 4 is 36. For each row of DRAM memory chips a command and address buffer chip is provided. A command and address buffer chip receives K external input signals such as selection signals, address signals and control signals and drives this input signals to all DRAM chips within the corresponding row. The number K of driven signals is in a typical embodiment 28 signals, so that the bus width K of the command and address bus between the command and address buffer chip and DRAM chips is 28.

FIG. 5 shows a register die element for a conventional command and address buffer chip as shown in FIG. 4. Each external signal applied to the command and address buffer chip from the main board is applied to two drivers D provided within a register die of said buffer chip. The conventional command and address buffer register according to the state of the art as shown in FIG. 5b comprises only one register die integrated into the package of said buffer chip.

To increase the memory capacity of the dual inline memory module the number of memory ranks within each DRAM memory chip is increased by stacking more memory dies within one DRAM package. The number N of DRAM chips on a dual inline memory module is limited because there is not enough space on the printed circuit board to add further DRAM chips. Consequently more memory ranks are integrated into one DRAM chip, wherein the DRAM memory dies are stacked over each other within the package. However, when increasing the number of DRAM memory dies the load to be driven by each signal driver within the command and address buffer chip is also increased.

FIG. 6a, 6b shows a command and address buffer chip within a dual inline memory module according to the state of the art as shown in FIG. 4 in more detail. The buffer chip comprises two register dies stacked within the package of said chip. Each external signal is supplied to two pairs of signal drivers, wherein the first pair of signal drivers is provided within a first register die and the second pair is provided within a second register die of said buffer chip. The dies are placed either one above the other or side by side. The size of DRAM-dies is normally big so that they are commonly placed one above the other. For each internal input signal applied to the buffer chip from the main-board two copy signals are generated wherein the first signal copy is supplied to the DRAM memory chips on the left side of the printed circuit board and wherein the second copy signal is applied to the DRAM memory chips on the right side of the printed circuit board.

As can be seen from FIG. 6 each signal line of the command and address bus between the buffer chip and the DRAM chips is driven by only one signal driver. Since there is only one signal driver for each command and address signal applied to the DRAM chips via the command and address bus the load for each signal driver is high so that the operation frequency of the conventional dual inline memory module (DIMM) as shown in FIG. 4 is limited. Each DRAM chip has a separate DQ-data bus for exchanging data with the main board. The DQ-data busses are normally operated at a double data rate (DDR) i.e. they run at twice the system clock rate f_{CLK}. Because of the high load connected to each signal driver within the command and address buffer chip in a conventional dual inline memory module (DIMM) the command and address bus is normally run at limited operation frequency which doesn't exceed half the system clock rate.

Accordingly it is the object of the present invention to provide a buffer chip for a multi-rank dual inline memory module which allows a maximum operation frequency.

This object is achieved by a buffer chip having the features of claim 1.

The present invention provides a buffer chip for driving internal input signals applied to a multi-rank dual inline memory module (MR-DIMM) to a predetermined number (N) of memory chips mounted in a printed circuit board (PCB) of said multi-rank dual inline memory module, wherein the buffer chip comprises

stacked register dies each having several signal drivers,

wherein at least two signal drivers provided on the same register die are connected in parallel to drive an external input signal to said memory chips.

With the buffer chip according to the present invention it is possible to run the dual inline memory module at 1 CA instruction per system clock. The buffer chip according to the present invention increases the power output on each signal line connecting the buffer chip with the DRAM chips. Accordingly the buffer chip according to the present invention can drive more DRAM chips mounted on the printed circuit board for a given operation frequency. Conversely for a given number of DRAM chips mounted on the dual inline memory module printed circuit board the operation frequency can be increased when using the buffer chip according to the present invention.

In a preferred embodiment the buffer chip according to the present invention is a command and address buffer chip for driving command and address signals to the memory chips.

In a preferred embodiment the buffer chip is located in the center of the printed and circuit board of the dual inline memory module.

In a preferred embodiment the memory chips driven by the buffer chip according to the present invention are DRAM memory chips.

In a preferred embodiment the buffer chip is operated at 1 CA instruction per system clock.

In a preferred embodiment the number of stacked register dies integrated within the buffer chip according to the present invention corresponds to the number of memory dies/chips on the DIMM.

In a preferred embodiment the buffer chip according to the present invention comprises a phase locked loop (PLL) to which an external clock signal is applied.

### BRIEF DESCRIPTION OF THE DRAWINGS

FIG. 1 shows a dual inline memory module according to the state of the art from above;

FIG. 2 is a cross section view of a dual inline memory module according to the state of the art as shown in FIG. 1;

FIG. 3 shows a cross section of the stacked DRAM memory chip according to the state of the art;

FIG. 4 shows a further dual inline memory module according to the state of the art from above;

FIG. 5a shows a register die element for driving one external signal within a conventional command and address buffer chip according to the state of the art as shown in FIG. 4;

FIG. 5b shows a cross section through a conventional command and address buffer chip according to the state of the art as shown in FIG. 4;

FIG. 6a shows the signal drivers for copying an external input signal within a conventional command and address buffer chip as shown in FIG. 4;

FIG. 7a, 7b, 7c show a first embodiment of the buffer chip according to the present invention;

FIG. 8a, 8b show a second embodiment of the buffer chip according to the present invention;

FIG. 9a, 9b show a third embodiment of the buffer chip according to the present invention.

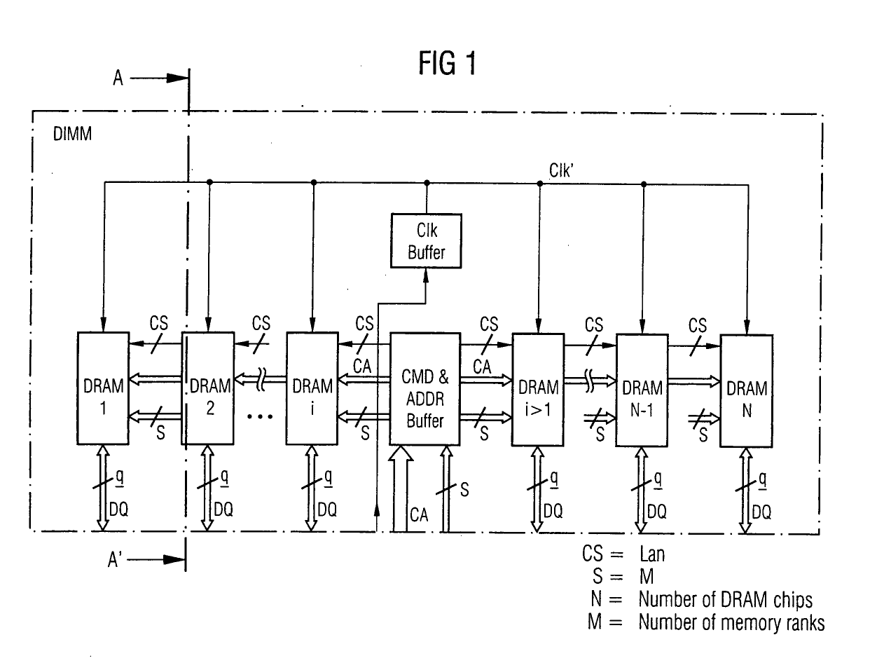

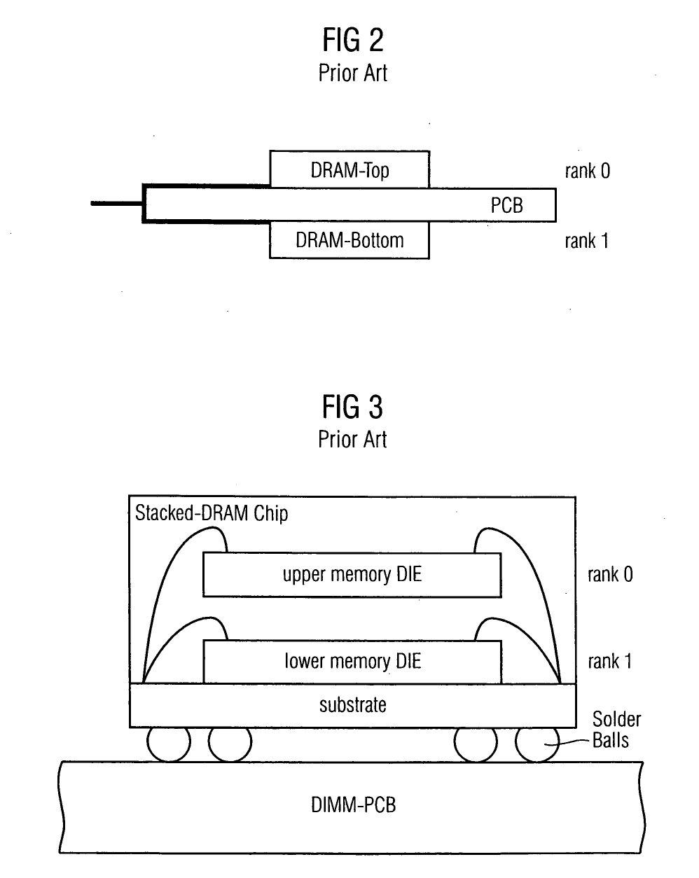

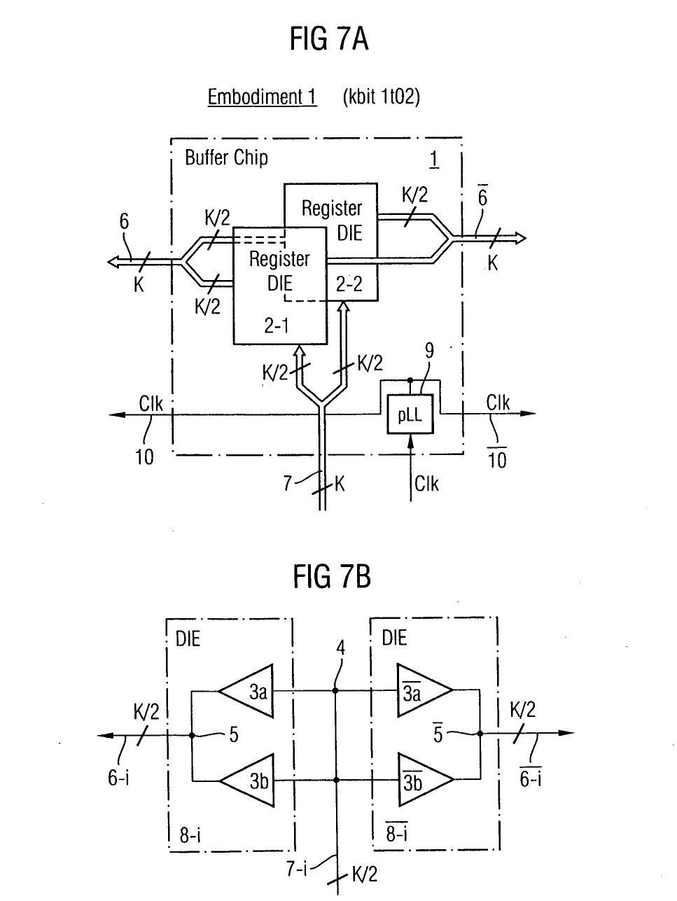

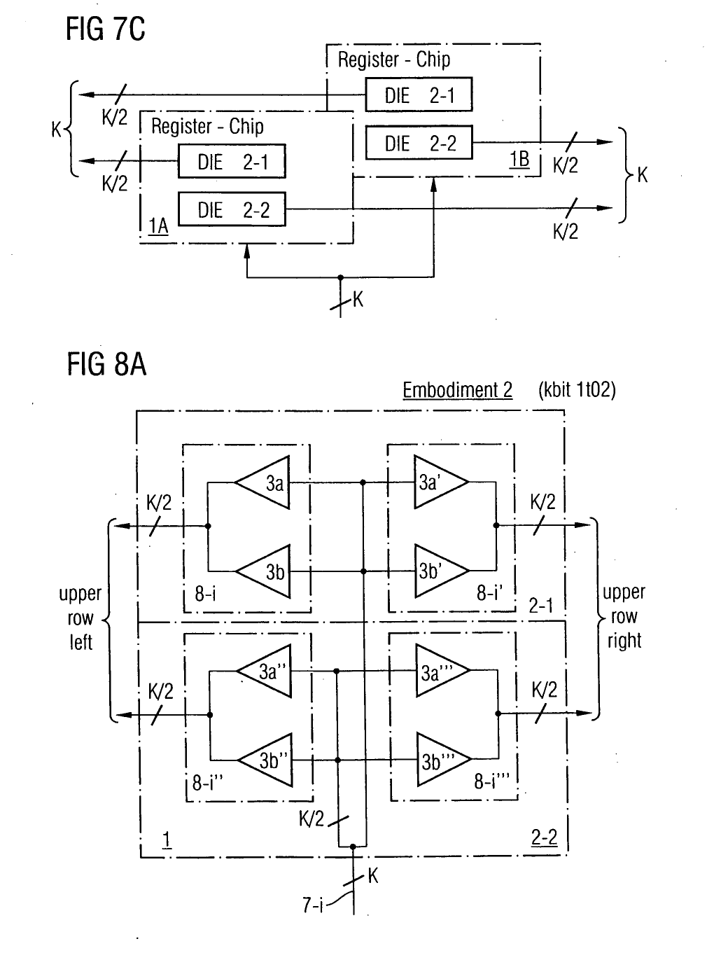

Referring to FIG. 7a it shows a first embodiment of a buffer chip 1 according to the present invention.

In the shown embodiment the buffer chip 1 comprises two stacked register dies 2-1, 2-2 wherein each registered die 2-1, 2-2 comprises a plurality of signal drivers 3 as shown in FIG. 7b. In the shown embodiment a pair of signal drivers 3a, 3b are connected in parallel to each other wherein each pair of signal drivers 3a, 3b receive on its input side an external input signal applied to the dual inline memory module from a motherboard and outputs the buffered signal at a common output terminal.

As can be seen from FIG. 7b both pairs of signal drivers 3a, 3b provided in the upper register 3 and in the bottom register 2 of said buffer chip 1 have a common input node 4 and an output node 5. The buffer chip 1 according to the present invention forms in a preferred embodiment a command and address buffer chip for a multi-rank dual inline memory module. The buffer chip 1 is provided for driving K command and address signal lines of a command and address bus 6 provided on a printed circuit board of the dual inline memory module. In the shown embodiment a command and address bus 6 connects the buffer chip 1 to all DRAM chips mounted on the left side of the printed circuit board and a second command and address bus \overline{6} connects the buffer chip 1 to all DRAM memory chips on the right side of the printed circuit board. The external input signals supplied by the processor mounted on the motherboard to the dual inline memory module are applied to the buffer chip 1 on the dual inline memory module via an input control bus 7 as shown in FIG. 7a. The bus width of this input control bus is K. In the embodiment shown in FIG. 7a the K input signal lines are split into two groups each having K/2 input lines. The first group of input lines is connected to the upper register die 2-1 and the second group is connected to a bottom register die within the buffer chip 1. Each input signal line 7-i is connected to two die elements 8-i, \overline{8-i} on the same register die wherein each die element comprises two signal drivers 3a, 3b which are connected in parallel between nodes 4, 5. While connecting two signal drivers 3a, 3b in parallel within each die element 8-i each command and address signal driven by the buffer chip 1 according to the present invention is driven with more power. Accordingly the number N of DRAM chips connected to each command and address signal line on the dual inline memory module can be increased for a given operation frequency. For a given number N of DRAM chips mounted on the dual inline memory module the operation frequency can be increased when using a buffer chip including parallel signal drivers 3a, 3b within each die element 8-i. For each output command and address signal line 6-i a corresponding die element 8-i is provided within the buffer chip 1. Within each die element 8-i at least two signal drivers 3a, 3b are provided wherein said signal drives 3a, 3b are connected in parallel to each other.

In an alternative embodiment each die element 8-i comprises more than two signal drivers, for instance four signal drivers. This allows an even higher number of DRAM memory chips which can be connected to each command and address signal line 6-i. For each input signal bit two copies are generated by the buffer chip 1 as shown in FIG. 7a. Accordingly FIG. 7a shows a K bit 1 to 2 buffer chip 1 according to a first embodiment.

As shown in FIG. 7c in a possible further embodiment the die elements 8-i within the upper register die 2-1 drive the DRAM chips on the left side of the dual inline memory module and the die elements provided within the bottom register die 2-2 are provided for driving the DRAM chips on the right side of the module. By connecting two buffer chips 1 according to the present invention in parallel it is possible to drive a control bus 6 having K signal lines.

In an alternative embodiments all die elements 8-i within the first buffer chip 1A are provided for driving the DRAM chips on the left side of the dual inline memory module and all die elements within the second buffer chip 1B are provided for driving the DRAM chips 1 on the right side of the dual inline memory module. In both embodiments the die elements 8-i, \overline{8-i} as shown in figure 7b belong to the same register die 2-i, i.e. a first register die 2-1 or a second register die 2-2 which are either placed one above the other or side by side.

In a preferred embodiment the number of register dies 2i within the buffer chip 1 according to the present invention corresponds to the number M of memory ranks within each DRAM memory chip mounted on the printed circuit board (PCB) of the dual inline memory module (DIMM).

In a preferred embodiment the buffer chip 1 according to the present invention further comprises a phase locked loop 9 for driving an external clock signal applied to the dual inline memory module by the motherboard. The phase locked loop 9 drives the clock signal to the DRAM chips on the dual inline memory module via clock lines 10, \overline{10}.

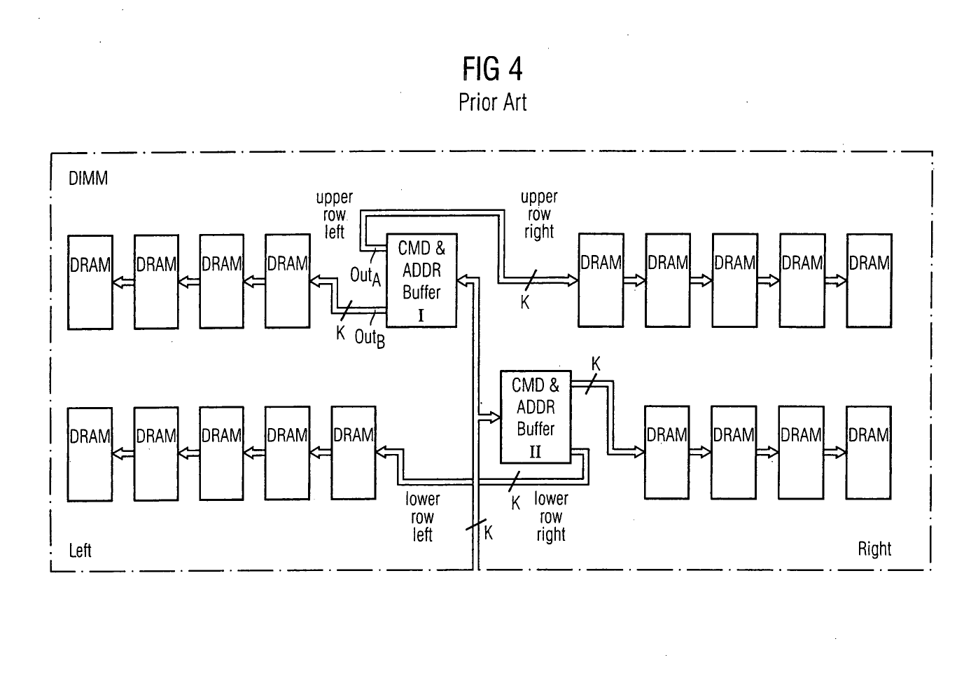

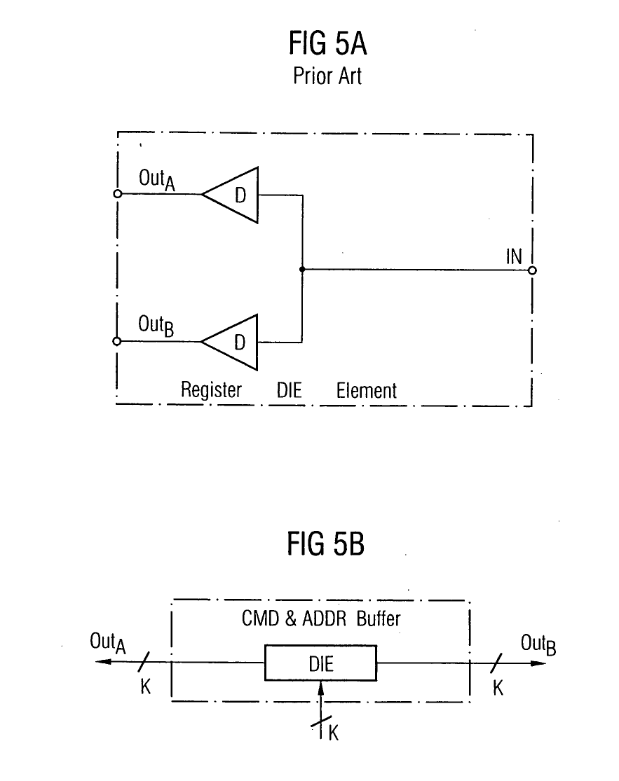

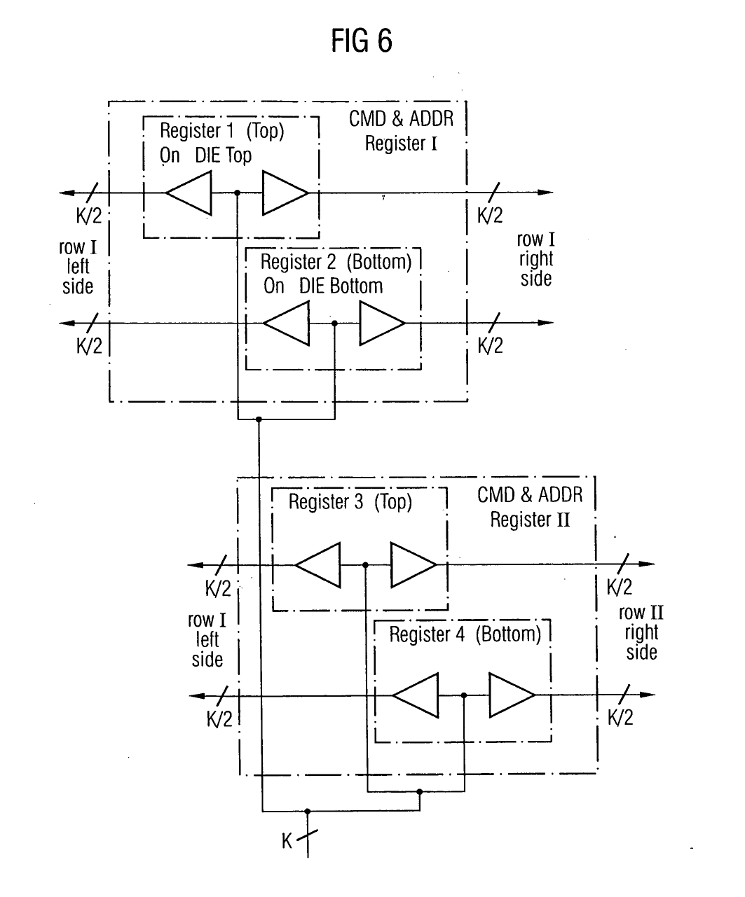

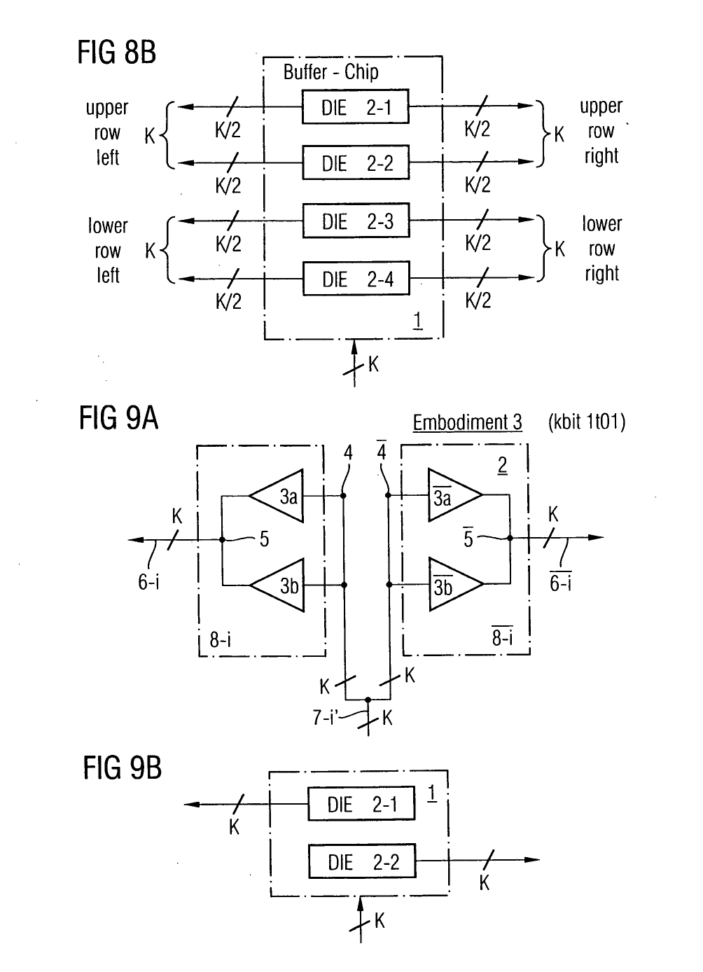

FIG. 8a, 8b show a further embodiment of the buffer chip 1 according to the present invention. In this embodiment the buffer chip 1 comprises four register dies 2-1, 2-2, 2-3, 2-4 stacked within the same package. For each input signal two copy signals are generated by the buffer chip 1 by means of a respective pair of buffer elements. The pair of buffer elements 8-i each having two signal drivers 3a, 3b generating two copy signals for an external input signal are provided within the same register die 2-i of the buffer chip 1. By stacking four register dies 2-i within one buffer chip 1 it is possible to drive more DRAM memory chips in a dual inline memory module wherein the DRAM memory chips are provided for instance in two rows on the printed circuit board of the dual inline memory module as shown in figure 4. By integrating four register dies 2-1 to 2-4 within one buffer chip 1 it is possible to substitute the two command and address buffer chips I, II as shown in FIG. 4 by a single buffer chip 1 according to the present invention. In this manner signal delays on the printed circuit board (PCB) of the dual inline memory module are compensated when using a buffer chip 1 according to the present invention because of the symmetric structure of the assembly.

FIG. 9 shows a further embodiment of the buffer chip 1 according to the present invention wherein for each input signal two copy signals are generated. Each copy signal is generated by means of die elements 8-i having two signal drivers 3a, 3b connected in parallel to each other. In the embodiment as shown in FIG. 9 the die elements 8-i, \overline{8-i}are provided within different register dies 2-i of the buffer chip 1.

In all embodiments the number of signal drivers 3 within die element 8-i can be adapted to the number of DRAM chips connected to the buffer chip 1 according to the present invention. In the embodiments shown in FIG. 7 to 9 each die element 8-i comprises two signal drivers 3a, 3b which are connected in parallel. In an alternative embodiments the number of signal drivers which are connected in parallel is higher, for instance three, four and more signal drivers 3.

The number of register dies 2-i within the buffer chip 1 according to the present invention is different in different embodiments. In the embodiments shown in FIG. 7, 9 the number of register dies 2-i is two. In the embodiment shown in FIG. 8 the number of register dies 2-i is four. In further embodiments the number of register dies 2-i within a buffer chip 1 according to the present invention is even higher such as even eight register dies 2-1 to 2-8 stacked upon each other.

By stacking the register dies within the buffer chip 1 it is possible to reduce the number of buffer chips mounted on the printed circuit board (PCB) thus increasing reliability and diminishing production costs. Further routing of the control lines on the printed circuit board becomes easier. A further advantage of the buffer chip 1 according to the present invention is that it can be formed in a symmetric manner such as shown in FIG. 8b. When comparing FIG. 4 showing a dual inline memory module (DIMM) according to the state of the art having two separate command and address buffer chips I, II for the two rows of DRAMs the dual inline memory module with the buffer chip 1 as shown in FIG. 8b buffering the command and address signals for both rows of DRAM chips it becomes evident that the routing for control signal lines is simplified when using the buffer chip 1 according to the present invention. Further delay differences between the control signals for the left side and the right side of the dual inline memory module are minimized because of the symmetric structure. Since only one buffer chip 1 according to the present invention is provided on each side of the printed circuit board (PCB) of the dual inline memory module (DIMM) as shown in FIG. 8b area on the printed circuit board (PCB) can be saved. By connecting the outputs of at least two signal drivers 3a, 3b in parallel stronger drivers are created applying an output signal with a higher power so that a higher number of DRAM chips on the dual inline memory module (DIMM) can be driven.

What is claimed is:

1. Buffer chip for driving external input signals applied to a multi-rank dual inline memory module to a predetermined number N of memory chips mounted on a printed circuit board of said dual inline memory module, wherein the buffer chip comprises stacked register dies each having several signal drivers, wherein at least two signal drivers are connected in parallel to drive an external input signal to said memory chips.

2. Buffer chip according to claim 1 wherein the buffer chip is a command and address bus buffer chip for driving command and address signals to said memory chips.

3. Buffer chip according to claim 1 wherein the buffer chip is located in the center of the printed circuit board of said dual inline memory module.

4. Buffer chip according to claim 1 wherein the memory chips are DRAMs.

5. Buffer chip according to claim 1 wherein the buffer chip is operated at a system clock rate.

6. Buffer chip according to claim 1 wherein the number of stacked register dies integrated within the buffer chip corresponds to the number of memory dies integrated within each memory chip.

7. Buffer chip according to claim 1 wherein the buffer chip further comprises a phase locked loop to which an external clock signal is applied.

8. Buffer chip according to claim 1 wherein two signal drivers are connected in parallel to form a die driver element pair.

9. Buffer chip according to claim 1 wherein the signal drivers which are connected in parallel are provided on the same register die of said buffer chip.
